(19) United States
(12) Patent Application Publication
(10) Pub. No.: US 2022/0138328 A1
(43) Pub. Date: May 5, 2022

(54) VALIDATION OF TRANSACTION LEDGER CONTENT USING JAVA SCRIPT OBJECT NOTATION SCHEMA DEFINITION

(71) Applicant: SAP SE, Walldorf (DE)

(72) Inventors: Johannes Weber, Schriesheim (DE); Andreas Krompholz, Heidelberg (DE); Jinesh Krishnan, Wiesloch (DE)

(21) Appl. No.: 17/083,515

(22) Filed: Oct. 29, 2020

(51) Int. Cl. G06F 21/60; G06F 16/182; G06Q 20/38; G06F 16/11

(52) U.S. Cl. CPC G06F 21/602; G06F 16/116; G06Q 20/389; G06F 16/182

(57) ABSTRACT

Embodiments may be associated with a secure, distributed transaction ledger. The system may include a Database that contains electronic records providing JSON schema content format requirements. A computer processor of a content validation smart contract creation platform, coupled to the JSON schema data store, may access information in the JSON schema data store. The content validation smart contract creation platform may then automatically create a content validation smart contract based on the JSON schema content format requirements. The content validation smart contract may then be deployed by the content validation smart contract creation platform to the secure, distributed transaction ledger.

### BACKGROUND

A company, such as a supplier or buyer, might share information with other entities via a secure, distributed transaction ledger, such as one that uses blockchain technology. For example, suppliers might respond to a buyer's request for information via blockchain. To encourage efficiency and automation, the exchanged information may need to be a certain format (e.g., product name, price per unit, date of delivery, etc.). The exchange of improperly formatted information can lead to errors and time-consuming attempts to correct the data. Moreover, manually reviewing exchanged information may not be practical, especially when a substantial number of transactions are being processed. Thus, there is a need to automatically validate data published on the blockchain for syntactical correctness so that it can be automatically processed in subsequent Information Technology (“IT”) systems. Note that the validation should preferably be performed before the data is stored on the blockchain.

It would therefore be desirable to automatically provide validation of content for a secure, distributed transaction ledger in an efficient and accurate manner.

### SUMMARY

According to some embodiments, methods and systems may provide validation of content for a secure, distributed transaction ledger. A system may include a Java Script Object Notation (“JSON”) schema data store that contains electronic records providing JSON schema content format requirements. A computer processor of a content validation smart contract creation platform, coupled to the JSON schema data store, may access information in the JSON schema data store. The content validation smart contract creation platform may then automatically create a content validation smart contract based on the JSON schema content format requirements. The content validation smart contract may then be deployed by the content validation smart contract creation platform to the secure, distributed transaction ledger.

Some embodiments comprise: means for accessing information in a JSON schema data store, the JSON schema data store containing electronic records that provide JSON schema content format requirements; means for automatically creating, by a computer processor a content validation smart contract creation platform, a content validation smart contract based on the JSON schema content format requirements; and means for deploying the content validation smart contract via a secure, distributed transaction ledger.

Some technical advantages of some embodiments disclosed herein are improved systems and methods that provide validation of content for a secure, distributed transaction ledger in an efficient and accurate manner.

### BRIEF DESCRIPTION OF THE DRAWINGS

FIG. 1 is a high-level block diagram of a system in accordance with some embodiments.

FIG. 2 illustrates a method to provide validation of content for a secure, distributed transaction ledger according to some embodiments.

FIG. 3 is a blockchain network according to some embodiments.

FIGS. 4A and 4B are a JSON schema in accordance with some embodiments.

FIG. 5 is a valid JSON document according to some embodiments.

FIG. 6 is a content validation smart contract in accordance with some embodiments.

FIG. 7 is a more detailed content verification method according to some embodiments.

FIG. 8 is a digital supply chain for materials system in accordance with some embodiments.

FIG. 9 is a more detailed block diagram of a system according to some embodiments.

FIG. 10 is a human machine interface display according to some embodiments.

FIG. 11 is an apparatus or platform according to some embodiments.

FIG. 12 illustrates a smart contract database in accordance with some embodiments.

FIG. 13 illustrates a handheld tablet computer according to some embodiments.

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known methods, procedures, components and circuits have not been described in detail so as not to obscure the embodiments.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developer's specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

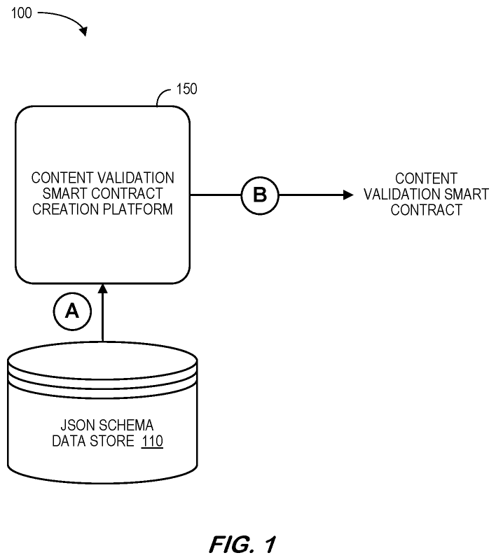

FIG. 1 is a high-level block diagram of a system 100 according to some embodiments. At (A), a content validation smart contract creation platform 150 may access information in a Java Script Object Notation (“JSON”) schema database 110 (e.g., an encrypted database). As used herein, the phrase “JSON schema” may refer to a vocabulary that lets an author annotate and validate JSON documents (e.g., to define a proper structure for content). That is, a JSON schema may describe existing data format(s) and may provide clear human-readable and/or machine-readable documentation to validate data (e.g., in connection with automated testing) to help ensure a high quality of client submitted data. A JSON schema may be associated with a standard such as the one defined at https://json-schema.org/.

At (B), the “automated” content validation smart contract creation platform 150 may receive information about content format and automatically create a smart contract. A used herein, the term “automated” may refer to a device or process that can operate with little or no human interaction. A used herein, the term “smart contract” may refer to a computer program or a transaction protocol that is intended to automatically execute, control, and/or document legally relevant events and actions according to the terms of a contract or an agreement. The objectives of a smart contract might include, for example, a reduction of need in trusted intermediators, arbitrations and enforcement costs, fraud losses, as well as the reduction of malicious and accidental exceptions.

The smart contract may be associated with a secure, distributed transaction ledger, such as one that uses “blockchain” technology. A blockchain is a growing list of records (“blocks”) that are linked using cryptography. Each block may contain a cryptographic hash of the previous block, a timestamp, and transaction data (e.g., represented as a Merkle tree). Because it is decentralized and distributed, a blockchain may provide resistance to data modification. It may represent an open, distributed ledger that can record transactions between two parties efficiently and in a verifiable and permanent way. For use as a distributed ledger, a blockchain is typically managed by a peer-to-peer network collectively adhering to a protocol for inter-node communication and validating new blocks. Once recorded, the data in any given block cannot be altered retroactively without alteration of all subsequent blocks, which requires consensus of the network majority. Blockchains are considered secure by design and exemplify a distributed computing system with high fault tolerance.

According to some embodiments, devices, including those associated with the system 100 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The elements of the system 100 may store information into and/or retrieve information from various data stores (e.g., the JSON schema data store 110), which may be locally stored or reside remote from the content validation smart contract creation platform 150. Although a single content validation smart contract creation platform 150 is shown in FIG. 1, any number of such devices may be included. Moreover, various devices described herein might be combined according to embodiments of the present invention. For example, in some embodiments, the content validation smart contract creation platform 150 and JSON schema data store 110 might comprise a single apparatus. Some or all of the system 100 functions may be performed by a constellation of networked apparatuses, such as in a distributed processing or cloud-based architecture.

A user (e.g., an operator or administrator) may access the system 100 via a remote device (e.g., a Personal Computer (“PC”), tablet, or smartphone) to view information about and/or manage operational information in accordance with any of the embodiments described herein. In some cases, an interactive graphical user interface display may let an operator or administrator define and/or adjust certain parameters (e.g., to setup company relationships) and/or provide or receive automatically generated recommendations or results from the system 100.

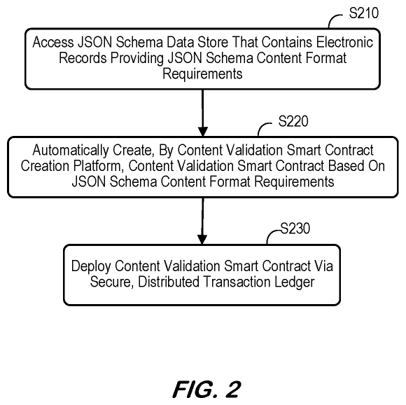

FIG. 2 illustrates a method to provide validation of content for a secure, distributed transaction ledger according to some embodiments. The flow charts described herein do not imply a fixed order to the steps, and embodiments of the present invention may be practiced in any order that is practicable. Note that any of the methods described herein may be performed by hardware, software, an automated script of commands, or any combination of these approaches. For example, a computer-readable storage medium may store thereon instructions that when executed by a machine result in performance according to any of the embodiments described herein.

At S210, a content validation smart contract creation platform may access information in a JSON schema data store (e.g., a database) that contains electronic and/or encrypted records providing JSON schema content format requirements (e.g., format requirements). At S220, the content validation smart contract creation platform or computer processor may automatically create a content validation smart contract (e.g., validation conditions) based on the JSON schema content format requirements (e.g., after decrypting the format requirements). At S230, the system may deploy the content validation smart contract via a secure, distributed transaction ledger (e.g., by encrypting the validation conditions and transmitting the encrypted data to a block file system associated with blockchain technology). When new content is published or transmitted to the secure, distributed transaction ledger, the content validation smart contract can be automatically executed to validate the newly published content.

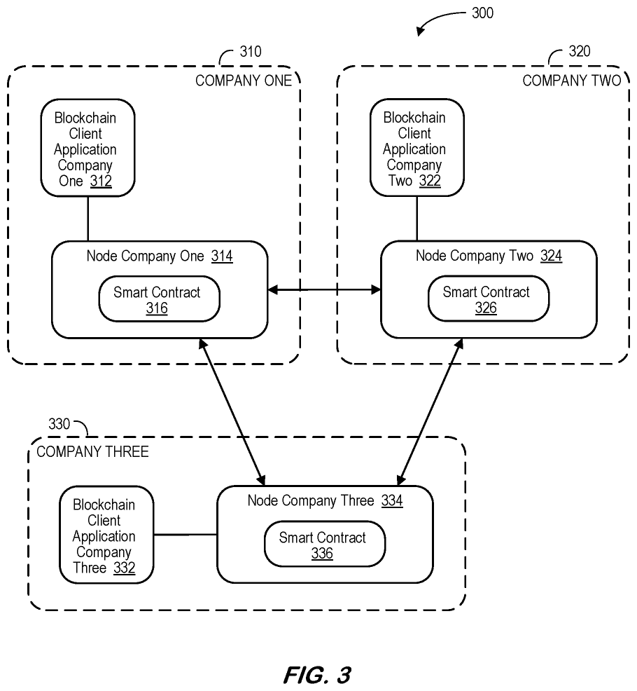

FIG. 3 is a blockchain network 300 according to some embodiments. The network 300 includes components associated with company one 310 including a blockchain client application 312, a node 314, and a smart contract 314 (e.g., for content validation in accordance with any of the embodiments described herein). Similarly, the network 300 includes components associated with company two 320 (including a blockchain client application 322, a node 324, and a smart contract 324) and with company three 330 (including a blockchain client application 332, a node 334, and a smart contract 334). Note that blockchain is a distributed network platform that can be used to store and share data across company borders. The network 300 consists of a set of blockchain nodes 314, 324, 334 that exchange information and each node 314, 324, 334 is usually assigned to one participating company. The blockchain protocol takes care of synchronizing the content of each node 314, 324, 334 to get a commonly agreed state of the network data.

The smart contracts 316, 326, 336 are a blockchain technology component that including a piece of programming code that is stored on the blockchain as data and is executed when reading/writing data from/to the blockchain. The openness of blockchain is a key capability of the technology that implies that every participant can store data on the blockchain network 300 without involving any central server for validations of the written content. On the other hand, there may be a need to have a commonly defined data structure on the network 300 so that every participant can access the data in a defined way.

According to some embodiments, data may need to be stored on the blockchain in a JSON compliant way. Embodiments may then provide a way to define a JSON schema for published data and use smart contracts 316, 326, 336 to validate the data with the defined schema. For example:
On a network 300 level, a JSON schema may be pre-defined for the data to be shared on the blockchain.
The JSON schema can also be stored on the blockchain to be immutable and distributed across all participants 310, 320, 330 of the network 300 so that every participant 310, 320, 330 can access the shared schema structure and see how the data to be shared on blockchain should be structured.
A smart contract 316, 326, 336 may be deployed on the blockchain that consists of the entire logic of the JSON schema validation without any external links (note that smart contract 316, 326, 336 might not permit external calls so as to guarantee stateless reproducible execution). The smart contract 316, 326, 336 may then be executed when new data is published to the blockchain to validate the content.

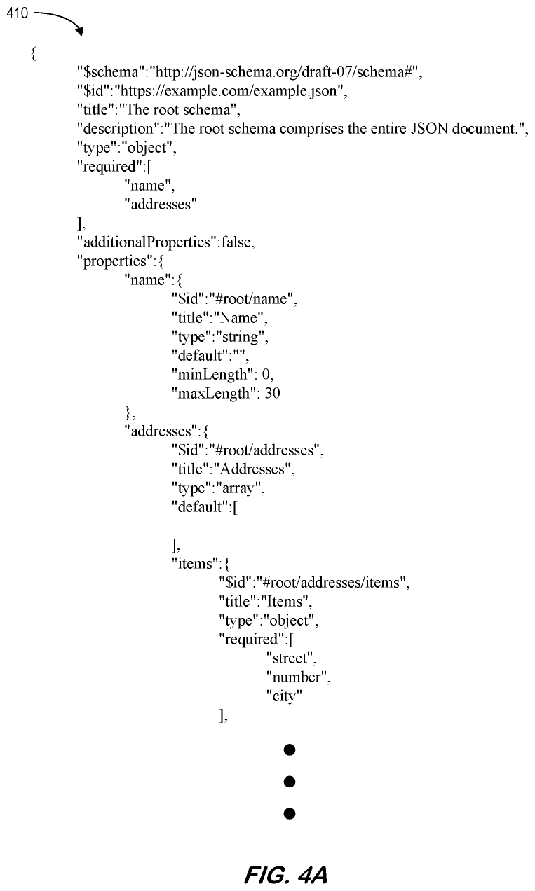

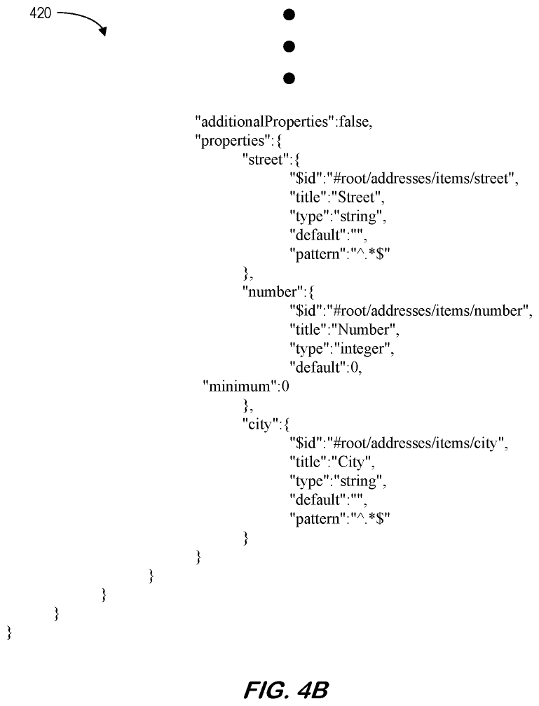

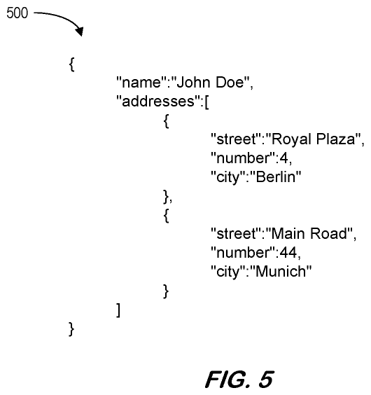

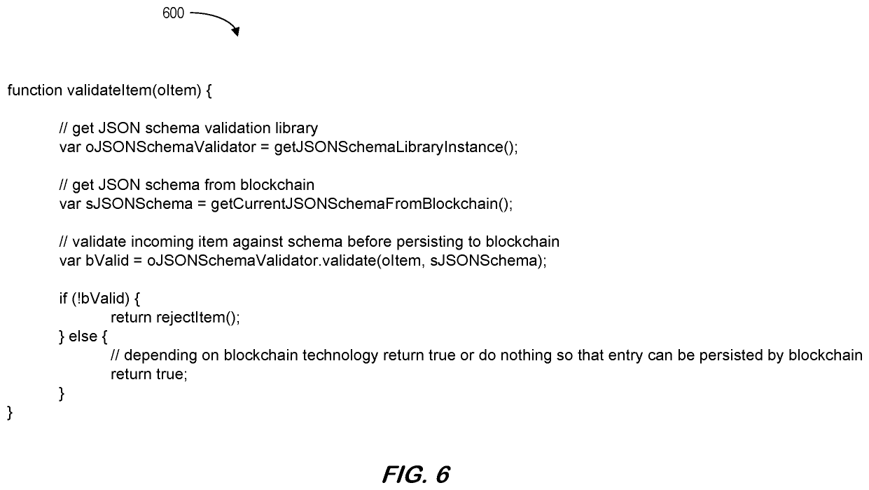

FIGS. 4A and 4B are a JSON schema 410, 420 in accordance with some embodiments. In particular, the JSON schema 410, 420 describes a data structure for people and addresses. A set of addresses may be associated with each person's name, and each address may include a street, a house or apartment number, and a city. FIG. 5 is a valid JSON document 500 according to some embodiments. The valid JSON document 500 conform to the JSON schema 410, 420 defined in FIGS. 4A and 4B and indicates that a person named “John Doe” is associated with addresses of “Royal Plaza, 4, Berlin” and “Main Road, 44, Munich.” FIG. 6 is a content validation smart contract 600 in accordance with some embodiments. The sample pseudocode for the smart contract 600 does the validation for incoming items which should be persisted on the blockchain.

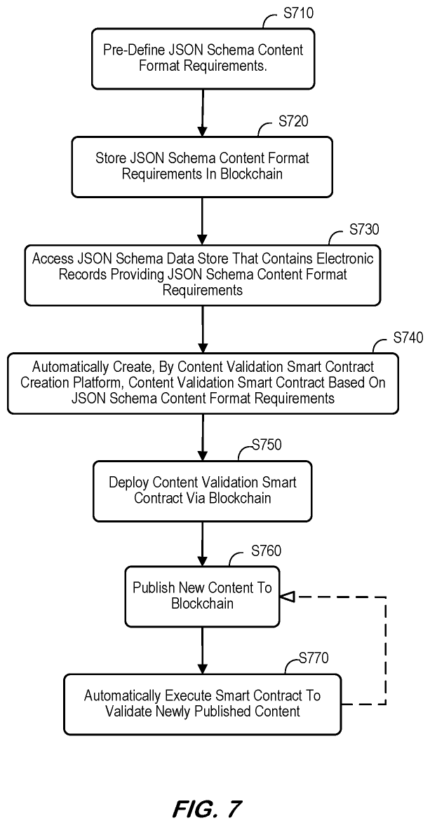

FIG. 7 is a more detailed content verification method according to some embodiments. At S710, JSON schema content format requirements may be pre-defined (e.g., by a buyer looking to purchase items or services from a supplier). The JSON schema format requirements may then be published to the blockchain at S720. At S730, a content validation smart contract creation platform may access information in a JSON schema data store that contains electronic records providing JSON schema content format requirements. At S740, the content validation smart contract creation platform may automatically a content validation smart contract or filter based on the JSON schema content format requirements. At S750, the system may deploy the content validation smart contract or filter via blockchain technology. When new content is published to the blockchain at S760, the content validation smart contract or filter can be automatically executed to validate the newly published content at S770. This process can continue at S760 as new content is published (as illustrated by the dashed arrow in FIG. 7).

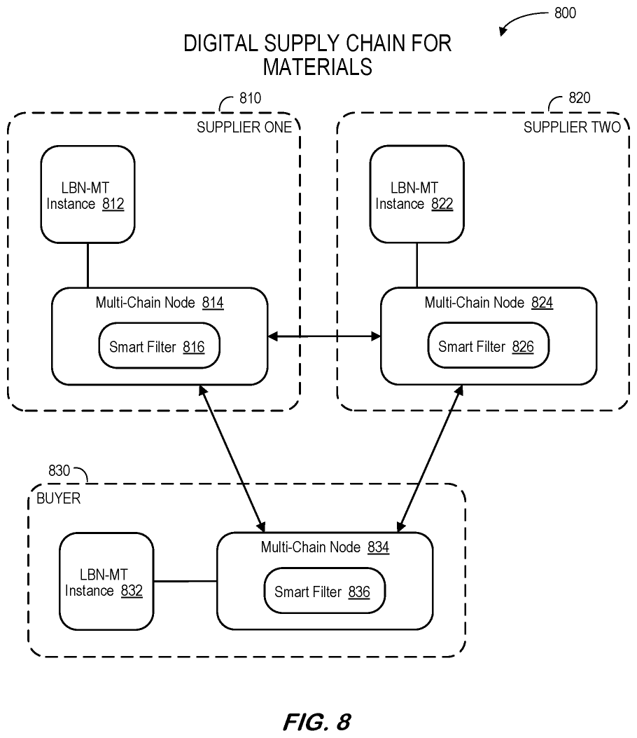

FIG. 8 is a digital supply chain for materials system 800 in accordance with some embodiments. The system 800 includes components associated with supplier one 810 including a Logistics Business Network-Material Traceability (“LBN-MT”) instance 812, a multi-chain node 814, and a smart filter 814 (e.g., for content validation in accordance with any of the embodiments described herein). Similarly, the system 800 includes components associated with supplier two 820 (including a LBN-MT instance 822, a multi-chain node 824, and a smart filter 824) and with a buyer 830 (including a LBN-MT instance 832, a multi-chain node 834, and a smart filter 834). In this way, a multi-chain blockchain platform using smart filters can implement Java script language for smart filter 816, 826, 836 logic. This concept may be used, for example, in LBN-MT to validate data on a blockchain to help build up a digital supply chain for materials associated with a buyer 830 and its suppliers 810, 820. The system 800 may let the buyer 830 to define a schema for the material data and enable the suppliers 810, 820 only store valid data for the digital supply chain.

Using a JSON schema as a language definition file for a data structure shared on the blockchain may allow for a flexible way to pre-define the structure of the data. Using a schema validation, every item of published data can be generically checked against a formal language. Such an approach may be more flexible and cost-effective as compared to implementing a dedicated check for every use case process. Additionally, the JSON schema may itself be stored on the blockchain to enable all participants to access it and get an overview of the data structure. This may allow them to always publish new data in a correct way.

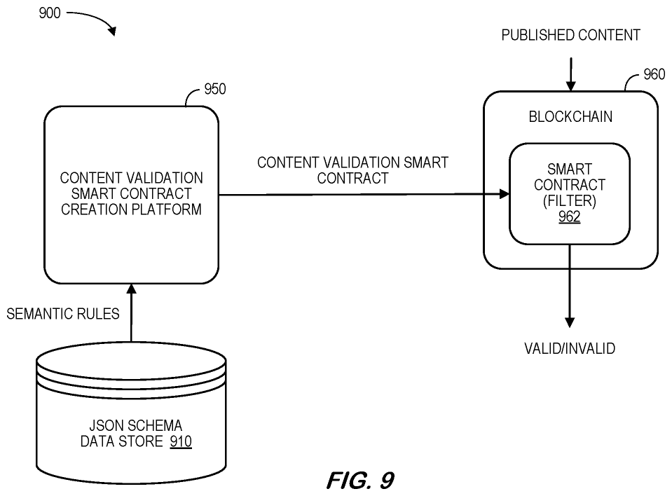

FIG. 9 is a more detailed block diagram of a system 900 according to some embodiments. As before, a content validation smart contract creation platform 950 may access information (e.g., semantic rules) from a JSON schema database 910. In this way, the automated content validation smart contract creation platform 950 may receive information about content format and automatically create a smart contract or filter 962 that can be published to the blockchain 960. When the blockchain 960 receives newly published content, the smart contract or filter 962 may be automatically executed to determine whether or not that content is in a valid format.

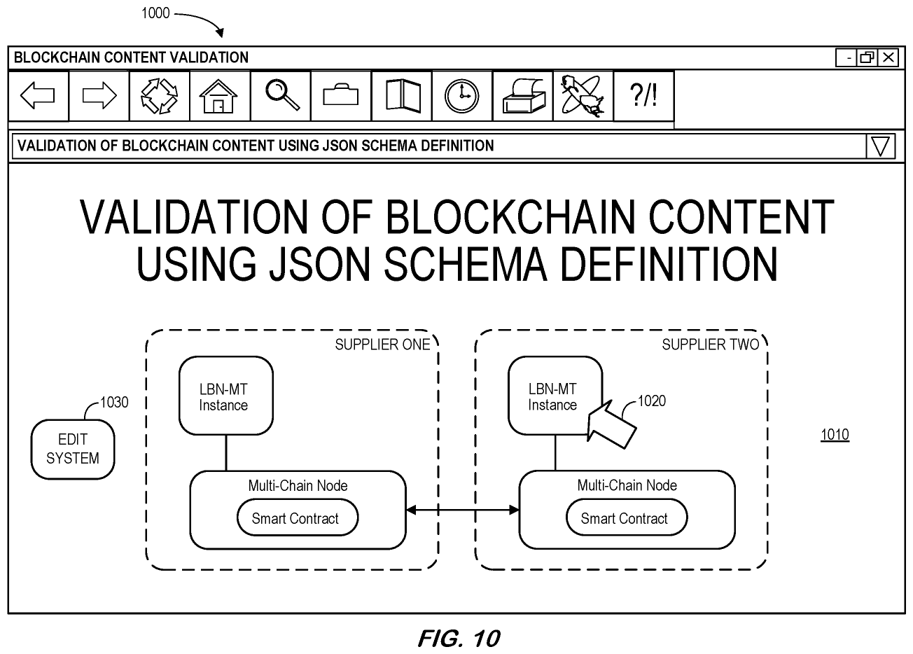

FIG. 10 is a human machine interface display 1000 in accordance with some embodiments. The display 1000 includes a graphical representation 1010 or dashboard that might be used to manage or monitor a blockchain content validation framework (e.g., associated with a secure, distributed transaction ledger). In particular, selection of an element (e.g., via a touchscreen or computer mouse pointer 1020) might result in the display of a popup window that contains configuration data. The display 1000 may also include a user selectable “Edit System” icon 1030 to request system changes (e.g., to adjust an LBN-MT instance, modify a smart contract parameter, etc.).

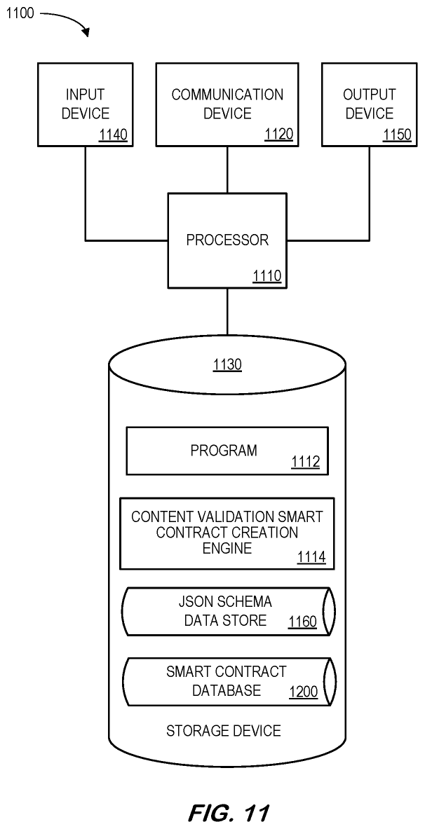

Note that the embodiments described herein may be implemented using any number of different hardware configurations. For example, FIG. 11 is a block diagram of an apparatus or platform 1100 that may be, for example, associated with the system 100 of FIG. 1 (and/or any other system described herein). The platform 1100 comprises a processor 1110, such as one or more commercially available CPUs in the form of one-chip microprocessors, coupled to a communication device 1120 configured to communicate via a communication network (not shown in FIG. 11). The communication device 1120 may be used to communicate, for example, with one or more remote user platforms, JSON schema data stores, etc. The platform 1100 further includes an input device 1140 (e.g., a computer mouse and/or keyboard to input information about content validation preferences) and an output device 1150 (e.g., a computer monitor to render a display, transmit recommendations or alerts, and/or create content validation reports). According to some embodiments, a mobile device and/or PC associated with an operator or administrator may be used to exchange information with the platform 1100.

The processor 1110 also communicates with a storage device 1130. The storage device 1130 can be implemented as a single database or the different components of the storage device 1130 can be distributed using multiple databases (that is, different deployment information storage options are possible). The storage device 1130 may comprise any appropriate information storage device, including combinations of magnetic storage devices (e.g., a hard disk drive), optical storage devices, mobile telephones, and/or semiconductor memory devices. The storage device 1130 stores a program 1112 and/or content validation smart contract creation engine 1114 for controlling the processor 1110. The processor 1110 performs instructions of the programs 1112, 1114, and thereby operates in accordance with any of the embodiments described herein. For example, the processor 1110 may access information in a JSON schema data store 1160. The processor 1110 may then automatically create a content validation smart contract based on the JSON schema content format requirements. The content validation smart contract may then be deployed by the processor 1110 to a secure, distributed transaction ledger.

The programs 1112, 1114 may be stored in a compressed, uncompiled and/or encrypted format. The programs 1112, 1114 may furthermore include other program elements, such as an operating system, clipboard application, a database management system, and/or device drivers used by the processor 1110 to interface with peripheral devices.

As used herein, information may be “received” by or “transmitted” to, for example: (i) the platform 1100 from another device; or (ii) a software application or module within the platform 1100 from another software application, module, or any other source.

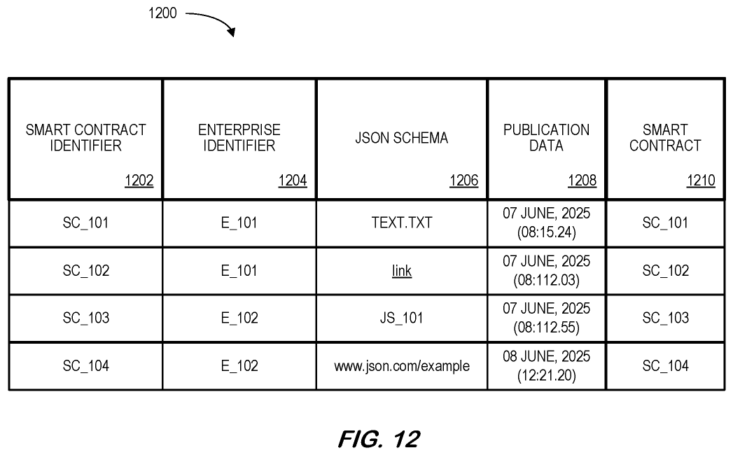

In some embodiments (such as the one shown in FIG. 11), the storage device 1130 further stores a smart contract database 1200. An example of a database that may be used in connection with the platform 1100 will now be described in detail with respect to FIG. 12. Note that the database described herein is only one example, and additional and/or different information may be stored therein. Moreover, various databases might be split or combined in accordance with any of the embodiments described herein.

Referring to FIG. 12, a table is shown that represents the smart contract database 1200 that may be stored at the platform 1100 according to some embodiments. The table may include, for example, entries identifying smart contracts or filters that can be deployed to validate content published via blockchain. The table may also define fields 1202, 1204, 1206, 1208, 1210 for each of the entries. The fields 1202, 1204, 1206, 1208, 1210 may, according to some embodiments, specify: a smart contract identifier 1202, an enterprise identifier 1204, a JSON schema 1206, publication data 1208, and a smart contract 1210. The smart contract data store 1200 may be created and updated, for example, when a new JSON format is defined, a smart contract is generated, etc.

The smart contact identifier 1202 identifier 1202 might be a unique alphanumeric label or link that is associated with a particular smart contract or filter that validates blockchain content in accordance with any of the embodiments described herein. The enterprise identifier 1204 might identify, for example, a buyer who defines the JSON schema 1206. The publication data 1208 might include a date and time of publication, a blockchain node identifier, etc. The smart contract 1210 may comprise executable code that contains all of the logic needed to verify published content.

In this way, embodiments may provide validation of content for a secure, distributed transaction ledger in an efficient and accurate manner. Note that embodiments may validate data published on a blockchain for syntactical correctness so that it can be automatically processed in subsequent IT systems. (and the validation might be executed before the data is stored on the blockchain). According to some embodiments, an increase in transaction growth and/or scale may be provided (e.g., because increased content accuracy may improve the quality of blockchain transactions) along with a reduced time to impact revenue (that is, content may be deployed and verified more quickly). Moreover, an increase of business growth, productivity, efficiency, and quality may be provided by the various embodiments described herein.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

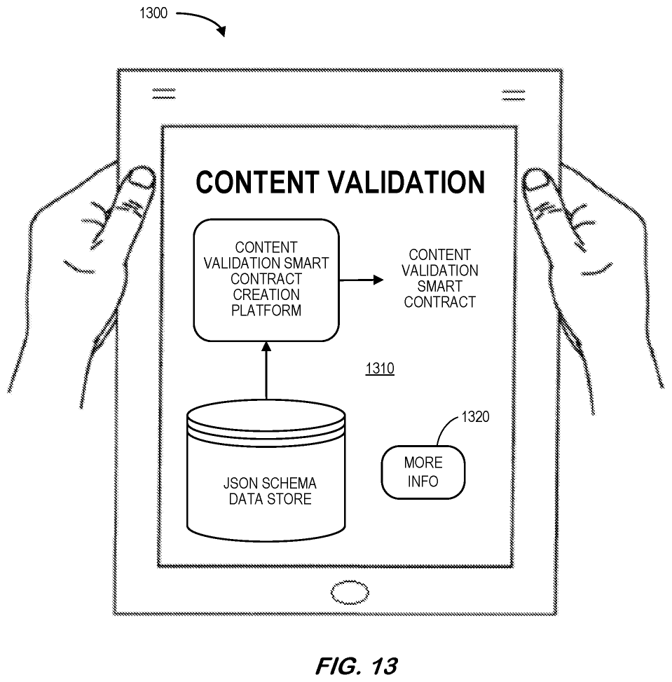

Although specific hardware and data configurations have been described herein, note that any number of other configurations may be provided in accordance with some embodiments of the present invention (e.g., some of the information associated with the databases described herein may be combined or stored in external systems). Moreover, although some embodiments are focused on particular types of blockchain transactions, any of the embodiments described herein could be applied to other types of business functions. Moreover, the displays shown herein are provided only as examples, and any other type of user interface could be implemented. For example, FIG. 13 shows a handheld tablet computer 1300 rendering a content validation display 1310 that may be used to monitor the performance of blockchain framework components and/or to request additional information (e.g., via a “More Info” icon 1320).

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

1. An apparatus, comprising:
a database containing encrypted records that provide format requirements;
a computer processor; and
a computer memory, coupled to the computer processor, storing instruction that, when executed by the computer processor cause the computer processor to:
access the database,
decrypt the encrypted data,
create validation conditions based on the format requirements,
encrypt the validation conditions, and
transmit the encrypted validation conditions to a secure, distributed block file system.

2. The apparatus of claim 1, wherein the validation conditions are applied to new transmissions to the secure, distributed block file system.

3. The system of claim 1, wherein execution of the instructions further cause the computer processor to:
pre-define the format requirements.

4. The system of claim 3, wherein the validation conditions contain the entire logic of the pre-defined format requirements without external links.

5. The system of claim 4, wherein the validation conditions comprise a node filter.

6. The system of claim 5, wherein the validation conditions are executed by a node application.

7. An apparatus, comprising:
a database containing encrypted records that provide format requirements;
a computer processor; and
a computer memory, coupled to the computer processor, storing instruction that, when executed by the computer processor cause the computer processor to:
access the database,
decrypt the encrypted data,
create validation conditions based on the format requirements,
encrypt the validation conditions, and
transmit the encrypted validation conditions to a secure, distributed file system.

8. The apparatus of claim 7, wherein the validation conditions are applied to new transmissions to the secure, distributed file system.

9. The system of claim 8, wherein execution of the instructions further cause the computer processor to:
pre-define the format requirements.

10. The system of claim 9, wherein the validation conditions contain the entire logic of the pre-defined format requirements without external links.

11. The system of claim 10, wherein the validation conditions comprise a node filter.

12. The system of claim 11, wherein the validation conditions are executed by a node application.

13. A method, comprising:
accessing information in a database, the database containing encrypted records that provide format requirements;
decrypting the encrypted data;
creating, by a computer processor, validation conditions based on the format requirements;
encrypting the validation conditions; and
transmitting the validation conditions to the secure, distributed file system.

14. The method of claim 13, further comprising:
transmitting a new file to the secure, distributed file system.

15. The method of claim 14, wherein the validation conditions are applied to the new file.
